(19) United States
(12) Patent Application Publication
(10) Pub. No.: US 2014/0215211 A1
(43) Pub. Date: Jul. 31, 2014

(54) SPLIT DATA EXCHANGE PROTOCOL

(71) Applicant: DW Associates, LLC, Austin, TX (US)

(72) Inventors: Manu Rehani, Portland, OR (US); Warren L. Wolf, Austin, TX (US)

(73) Assignee: DW Associates, LLC, Austin, TX (US)

(21) Appl. No.: 14/161,341

(22) Filed: Jan. 22, 2014

Related U.S. Application Data
(60) Provisional application No. 61/757,024, filed on Jan. 25, 2013.

(51) Int. Cl. G06F 21/14

(52) U.S. Cl. CPC G06F 21/14
USPC 713/168

(57) ABSTRACT

Embodiments of the invention include a system to manage software and protect it from reverse engineering and intrusion prevention. A security server stores server-side software and server-side keys for various software products. Client-side software can request the server-side software and server-side key from the security server. The security server can transmit the server-side software and server-side key to the client-side software, which can then determine whether or not to assemble and execute the complete software.

### RELATED APPLICATION DATA

This application claims the benefit of U.S. Provisional Patent Application Ser. No. 61/757,024, titled “SPLIT DATA EXCHANGE PROTOCOL”, filed Jan. 25, 2013, incorporated by reference herein.

### FIELD

This invention pertains to software security, and more particularly to protecting software against unauthorized use.

### BACKGROUND

Most software is licensed, rather than sold, by the company that developed the software. The license specifies what the customer can do with the software, and installation of the software implies the customer's acceptance of the software's license terms.

Installing software often involves using a code or key that limits the software's installation. When the customer attempts to install the software the customer is prompted for the code. The code is then transmitted back to the software company's servers, which validate the code and verify that the code has not been used before. Not all possible codes are valid, which prevents users from attempting to install in unauthorized copy of the program by trying random codes. If the code is valid and has not been used before, the company's servers record the use of the code, and the software is permitted to install. If the code is not valid, or if the code has been used before, the installation terminates.

But once the software is installed, nothing (other than perhaps a term in the license) prevents the installed software from being reverse engineered. A customer could attempt to recreate the source code for the software from the object code. With the source code in hand, the customer could then create their own version of the software.

Similarly, once the software is installed, nothing (other than perhaps a term in the license) prevents the user from copying the files and data that make up the software from one machine to another. This copying permits the software to run on the other machine, even though it might not have been properly installed on that machine, or authorized to run on that machine.

A need remains for a way to address these and other problems associated with the prior art.

### BRIEF DESCRIPTION OF THE DRAWINGS

FIG. 1 shows a security server that enables software to be installed on a client machine in a manner that prevents reverse engineering or software replication, according to an embodiment of the invention.

FIG. 2 shows the security server of FIG. 1, along with other security servers, connected via a network with the client machine.

FIG. 3 shows the security servers of FIG. 2 sending data to the client machine.

FIGS. 4A-4C show a flowchart of a procedure for a client machine to assemble and execute software, according to an embodiment of the invention.

FIGS. 5A-5B show a flowchart of a procedure for the security server of FIG. 1 to communicate with a client machine regarding the assembly and execution of software, according to an embodiment of the invention.

### DETAILED DESCRIPTION

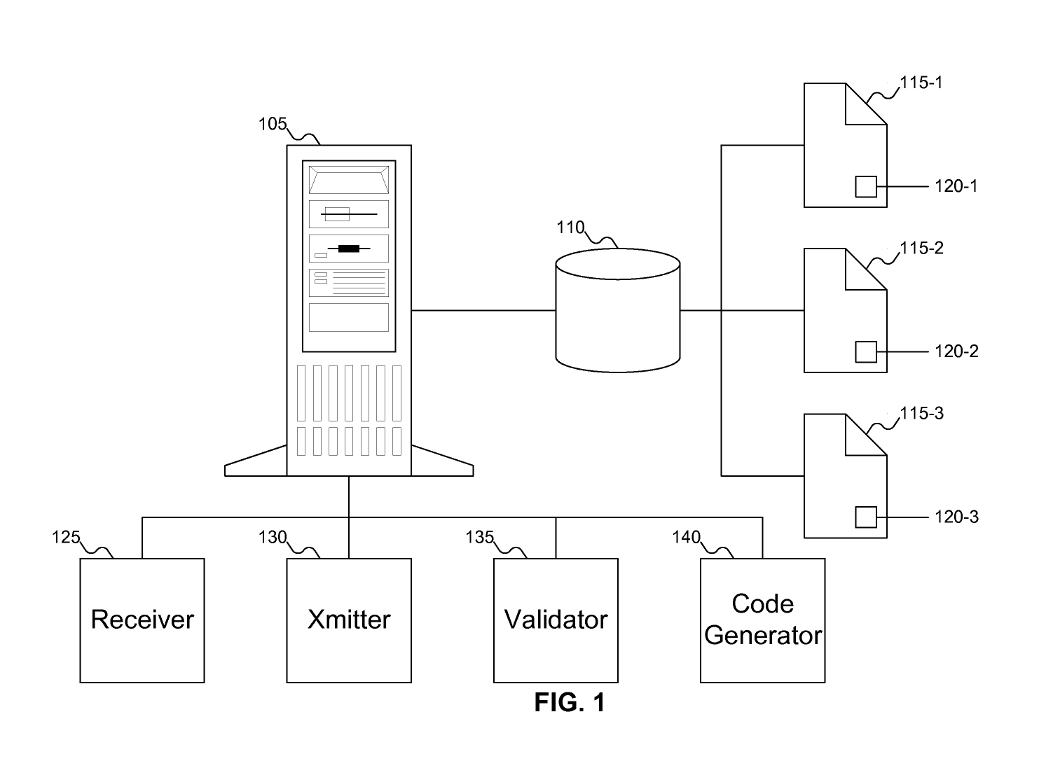

FIG. 1 shows a security server that enables software to be installed on a client machine in a manner that prevents reverse engineering or software replication, according to an embodiment of the invention. In FIG. 1, security server 105 is shown. Security server 105 can include commercial security mechanisms, to protect any data stored on security server 105. Security server 105 includes database 110, which stores server-side software 115-1, 115-2, and 115-3. Although FIG. 1 shows database 110 as including three server-side software products 115-1, 115-2, and 115-3, a person skilled in the art will recognize that database 110 can store any number of server-side software products. In addition, server-side software 115-1, 115-2, and 115-3 can be different software products, they can be multiple copies of the same software product, or both.

In some embodiments of the invention, server-side software 115-1, 115-2, and 115-3 can be a complete copy of the software, and can be executed by a user when available. But in other embodiments of the invention, server-side software 115-1, 115-2, and 115-3 is not a complete copy of the software. In such embodiments of the invention, server-side software 115-1, 115-2, and 115-3 needs to be combined with the client-side software to form a complete version of the software that can be executed.

Database 110 can also store server-side keys 120-1, 120-2, and 120-3. In some embodiments of the invention, server-side keys 120-1, 120-2, and 120-3 can be keys, or serial numbers, that correspond to a client-side key (that is, a key, or serial number, that is part of the software installed on the client's machine). In other embodiments of the invention, the server-side keys 120-1, 120-2, and 120-3 can be unique to different applications available from security server 105, but shared by all clients using the software. In yet other embodiments of the invention, a single server-side key can be used with any number of software products, and for any number of authorized users of those software products.

As with server-side software 115-1, 115-2, and 115-3, database 110 can store any number of server-side keys. Also, server-side keys 120-1, 120-2, and 120-3 can be stored directly in database 110 or, as shown in FIG. 1, server-side keys 120-1, 120-2, and 120-3 can be part of server-side software 115-1, 115-2, and 115-3. Server-side software 115-1, 115-2, and 115-3 can be multiple copies of the same server-side software, configured for use by different authorized users; or they can be different server-side software products. Server-side software 115-1, 115-2, and 115-3 can also include both multiple copies of the same server-side software for use by different authorized clients and different server-side software products.

Security server 105 also includes receiver 125, transmitter 130, validator 135, and code generator 140. Receiver 125 can be used to receive information at security server 105. For example, receiver 125 can be used to receive requests for server-side software and server-side keys. Transmitter 130 can be used to transmit information from security server 105. For example, transmitter 130 can be used to transmit server-side software and server-side keys responsive to requests for such.

Validator 135 can be used to validate that requests for server-side software and server-side keys are coming from client machines that are authorized to use the software. For example, when a client machine requests its server-side software and server-side key (for example, server-side software 115-2 and server-side key 120-2), the client machine can include information about the client machine, such as its Internet Protocol (IP) address. Security server 105 can use validator 135 to validate that the client machine is, in fact, authorized to use the software before transmitting server-side software 115-2 and server-side key 120-2 to the client machine.

Code generator 140 can be used to generate the server-side software before it is transmitted to a client machine. For example, in some embodiments of the invention, database 110 stores a separate copy of the server-side software for each authorized client. But storing multiple copies of the server-side software can require a significant amount of space. Therefore, in other embodiments of the invention, database 110 can store the source code (or code in some other form) that can be used to generate the server-side software before transmission to the client machine. Code generator 140 can, for example, compile, encrypt, and obfuscate the server-side software. In this manner, database 110 only needs to store one copy of the server-side software, along with the server-side keys for the authorized users (since the server-side key can be included within the server-side software transmitted to the client machine).

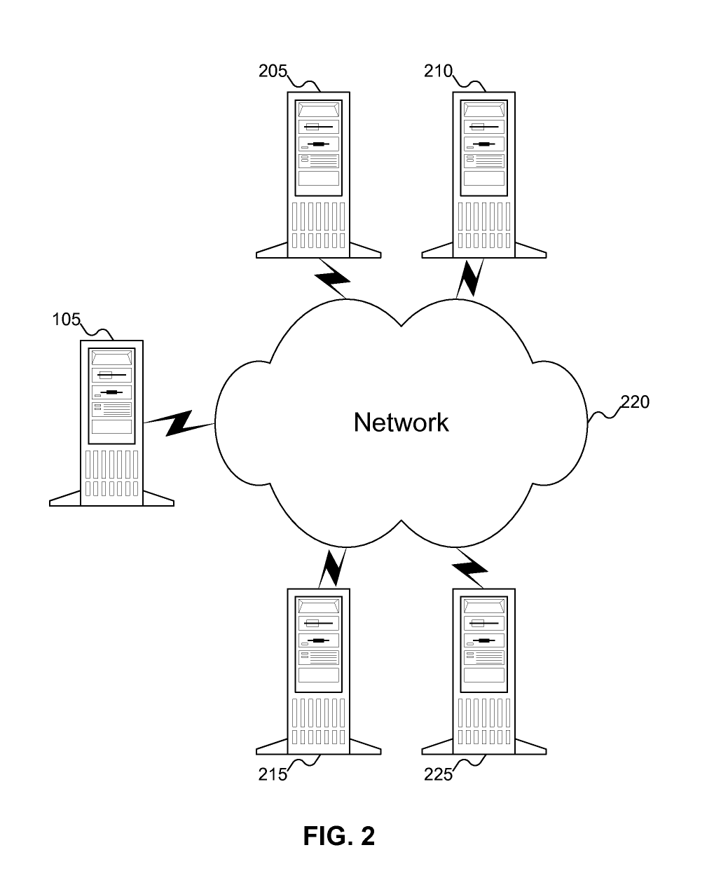

FIG. 2 shows the security server of FIG. 1, along with other security servers, connected via a network with the client machine. In FIG. 2, security server 105 is one of several security servers, including security servers 205, 210, and 215, connected via network 220. Network 220 can be any variety of networks, including a local area network (LAN), wide area network (WAN), or a global network, such as the Internet. In addition, network 220 can include both wired and wireless components in any desired configuration. While FIG. 2 shows four security servers, a person of ordinary skill in the art will recognize that there can be any number of security servers connected to network 220.

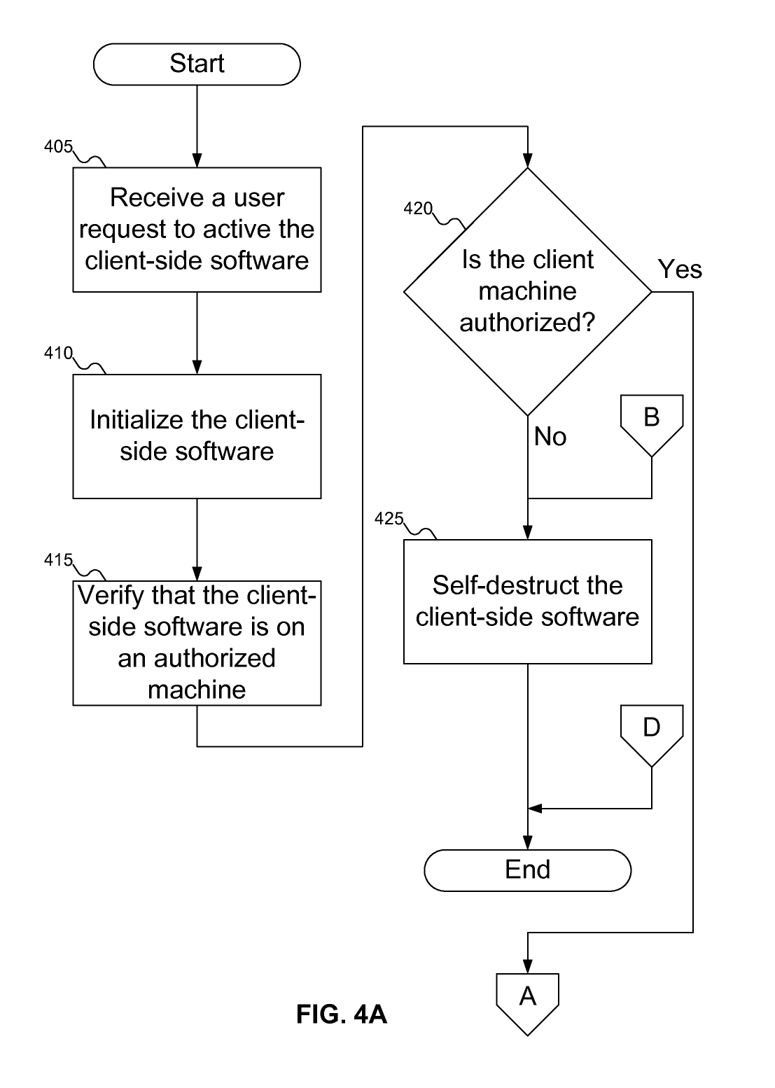

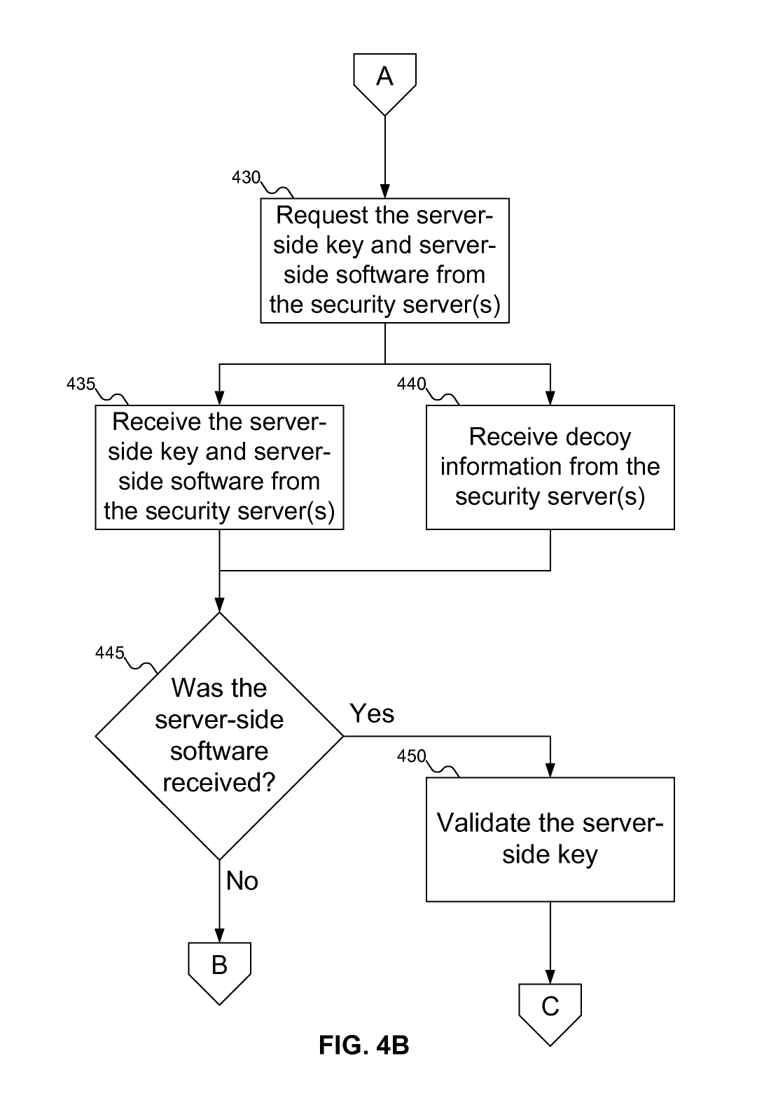

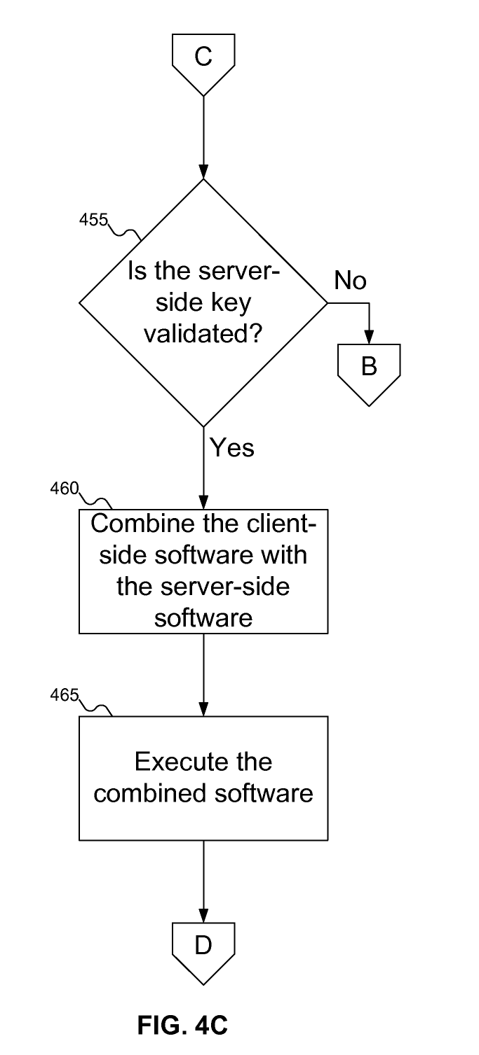

Also connected to network 220 is client machine 225. Client machine 225 represents a machine used by a user, on which the user wants to run the protected software. Client machine 225 can include commercial security mechanisms, to protect any data stored on client machine 225. Resident on the client machine is the client-side software. The client-side software is not a complete version of the software, but includes enough code to perform the necessary tasks before assembling the complete software for execution. The tasks in question are described below with reference to FIGS. 4A-4C. Aside from any commercial security mechanisms that can be included on client machine 225, the client-side software can also be compiled, encrypted, and obfuscated, to further protect the client-side software from copying and intrusion.

In some embodiments of the invention, security servers 105, 205, 210, and 215 can be synchronized, so that each security server includes the same information, and any security server can be accessed to assemble the complete software. But in other embodiments of the invention, security servers 105, 205, 210, and 215 are not necessarily synchronized. That is, security server 105 might have data not found on security servers 205, 210, and 215, security server 205 might have data not found on security servers 105, 210, and 215, etc.

In some embodiments of the invention, client machine 225 (more specifically, the client-side software installed on client machine 225) contacts only a security server that the client-side software knows stores the server-side software and server-side key. But in other embodiments of the invention, client machine 225 (again, more specifically, the client-side software installed on client machine 225) contacts every security server (for example, in serial or in parallel). This contact can occur even when the server-side software and server-side key are not available at every security server. Each security server can respond, either by transmitting the server-side software and server-side key or by transmitting decoy information. In this manner, security is enhanced, as an eavesdropper would not know which security servers actually store the server-side software and server-side key. (The client-side software installed on client machine can differentiate between the authentic and decoy security servers, in that only the authentic security server would have or use the correct server-side key.) Further, if an attacker were to attempt to request the server-side software from a security server that had transmitted decoy information (a fact the attacker should not be able to determine), this request would reveal that an attacker was attempting to assemble the complete software without authorization.

In some embodiments of the invention, in the event that an attack is suspected (for example, as described above, where a request for the server-side software is made from a security server that does not include the server-side software, or where the request for the server-side software comes from a client machine that is not authorized), the system can respond by changing the server-side keys that correspond to the client-side keys of the affected user. In this manner, further attempts by the attacker to establish the combined software will fail, as the client-side key the attacker has access to (albeit indirectly) will not be valid, causing the client-side software to self-destruct. And while this response to an attack can invalidate a legitimate client-side key (namely, the client-side key of the user who was compromised), that user can be issued a new valid client-side key (e.g., the authorized user can be provided with a new client-side software), permitting the authorized user to continue to use the software while denying the attacker the ability to use the software. In other embodiments of the invention, of course, the change to the server-side key can be done without affecting the client-side key, minimizing the inconvenience to the client.

While client machine 225 is part of the physical hardware that links the client-side software with the server-side software on one or more of security servers 105, 205, 210, and 215, client machine 225 should have no information about how to contact security servers 105, 205, 210, and 215. That is, the information about how to contact security servers 105, 205, 210, and 215 is part of the client-side software, and should not be known by client machine 225. In addition, the information used to contact security servers 105, 205, 210, and 215 (such as the protocols used to list and access security servers 105, 205, 210, and 215) can be part of the client-side software. As such, the contact information can be compiled, encrypted, and obfuscated into the client-side software, to make it more difficult (if not impossible) for an attacker to determine this information by analysis of the client-side software. In such embodiments of the invention, because the protocols to list and access security servers 105, 205, 210, and 215 can be part of the compiled, encrypted, and obfuscated client-side software, client machine 220 would not have a file (encrypted or not) that identifies how to contact security servers 105, 205, 210, and 215, thereby avoiding one possible attack.

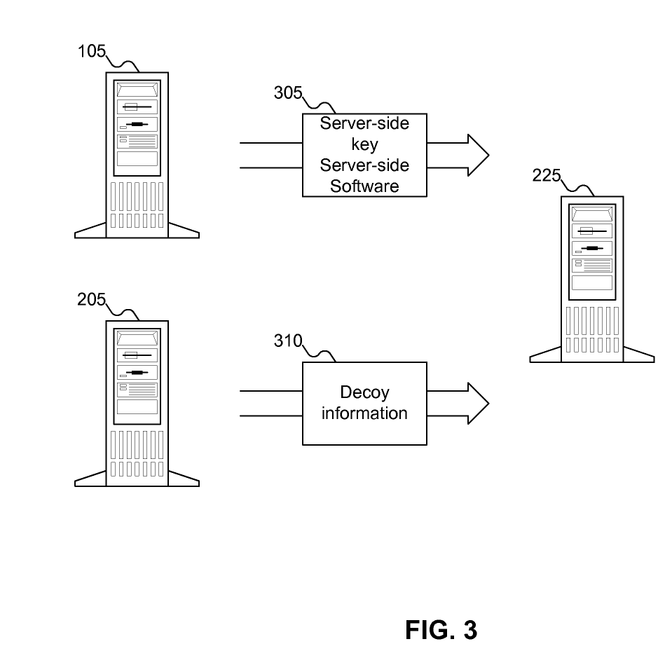

FIG. 3 shows the security servers of FIG. 2 sending data to the client machine. In FIG. 3, security server 105 includes the server-side software and server-side key, whereas security server 205 does not include that information. As discussed above, in some embodiments of the invention, when the client-side software installed on client machine 225 requests the security-side software and security-side key from the security servers, each security server can respond, even though not every security server necessarily includes the security-side software and security-side key. Thus, security server 105 transmits information 305, which includes the security-side software and security-side key, to client machine 225, whereas security server 205 transmits information 310, which includes dummy information, to client machine 225. As discussed above, the client-side software installed on client machine 225 can determine which security server provided the authentic information based on the server-side key corresponding to the client-side key.

FIGS. 4A-4C show a flowchart of a procedure for a client machine to assemble and execute software, according to an embodiment of the invention. In FIG. 4A, at block 405, the system receives a request from a user to activate the client-side software. At block 410, the client-side software is initialized. At block 415, the client-side software verifies that it is running on an authorized machine. This can be done in any number of ways: for example, the client-side software can determine the identity of the machine on which the client-side software is stored, and verify that the machine identity matches the identity of the machine on which the client-side software is supposed to be stored.

At block 420, the client-side software determines if the machine running the client-side software is authorized. If the machine running the client-side software is not authorized, then at block 425 the client-side software self-destructs. In some embodiments of the invention, self-destruction can include aborting the initialization of the client-side software. In other embodiments of the invention, self-destruction can also include deleting the client-side software from the machine. By deleting the client-side software from the machine, the client-side software cannot be executed again. This step can be useful in the situation where the client-side software has been copied onto a machine that is not authorized to execute the client-side software (for example, someone has hacked onto the client-side machine and copied its contents).

If the client-side software determines that the machine running the client-side software is authorized, then at block 430 (FIG. 4B), the client-side software requests the server-side software and the server-side key from the security servers. As discussed above, there can be more than one security server, and the client-side software can request the security-side software and the security-side key from any number of the security servers: one, all, or any number in between. In addition, the client-side software can request the server-side software and the server-side key in one request or two, and can receive the security-side software and security-side key in one transmission or two. Also, as discussed above, it might not be that all security servers include the server-side software and the server-side key. If the security server includes the server-side software and server-side key, then at block 435 the client-side software receives the server-side software and the server-side key. If the security server does not include the server-side software and the server-side key, then at block 440 the client-side software receives decoy information. Either way, at block 445 the client-side software determines if the server-side software (and server-side key) was received. If not, then processing returns to block 425 to self-destruct the client-side software.

As described in U.S. Provisional Patent Application Ser. No. 61/757,024, filed Jan. 25, 2013, the client-side software can self-destruct if the client-side software is unable to contact the security servers. While not shown explicitly in FIG. 4B, it should be recognized that if the client-side software cannot contact the security servers, then the client-side software will not receive any response from the security servers. Therefore, at block 445, the client-side software will self-destruct for failing to receive a response from the security servers, which produces the same result.

If the server-side software (and server-side key) was received, then at block 450 the client-side software attempts to validate the server-side key. This can be done in any desired manner. For example, the client-side software can verify whether the server-side key matches the client-side key (which can be determined by the client-side software) according to some algorithm.

At block 455 (FIG. 4C), the client-side software determines whether server-side key was validated. If the server-side key could not be validated, then processing returns to block 425 to self-destruct the client-side software. Otherwise, at block 460, the client-side software is combined with the server-side software to form the complete software in the memory of the client machine, and the complete software (at block 465) is then executed. By establishing the complete software in the memory of the client machine (and not storing the complete software anywhere), the complete software cannot be deciphered, which protects the complete software.

As discussed above, in block 430 of FIG. 4B, the client-side software can request server-side software and server-side key in one request or two. A person skilled in the art will recognize that these elements can be requested as needed. For example, the client-side software can request just the server-side key initially, and determine if the server-side key is validated. Then, only if the server-side key is validated, would the client-side software request the server-side software.

In a further variation, after validating the server-side key, the client-side software can request the server-side software from all security servers, or just from one or more security servers that store the server-side software. But by requesting the server-side software from all security servers—even those that send decoy information—the software is protected, since an attacker would not have any information as to which security servers store the server-side software and which are decoys.

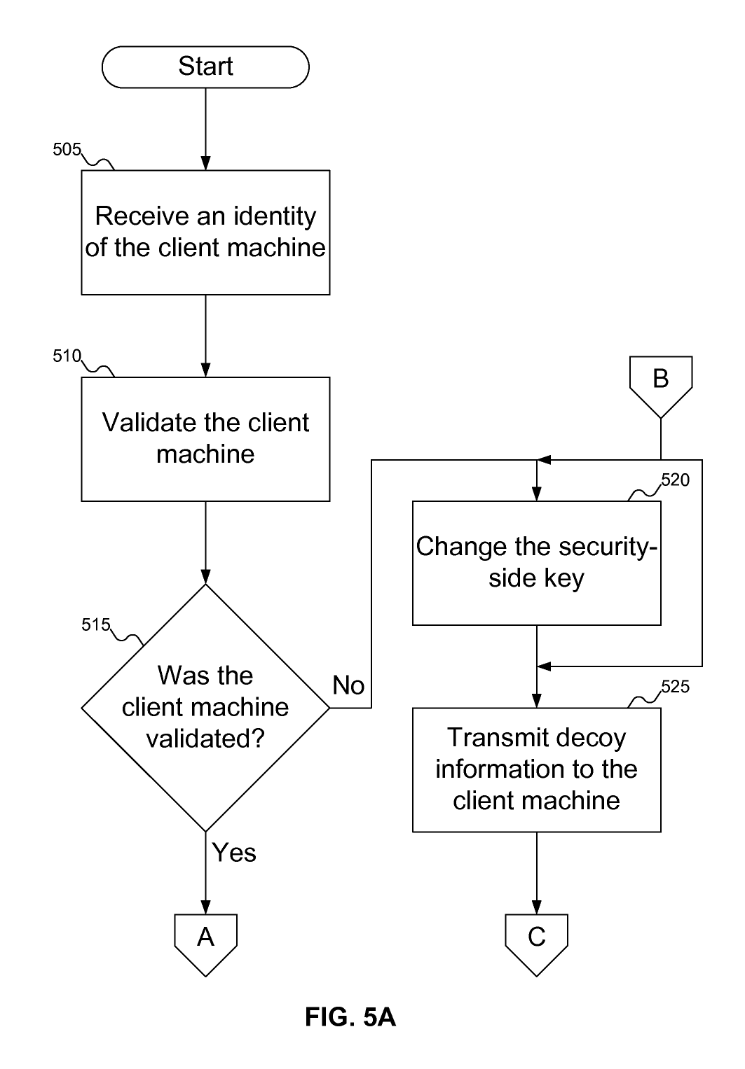

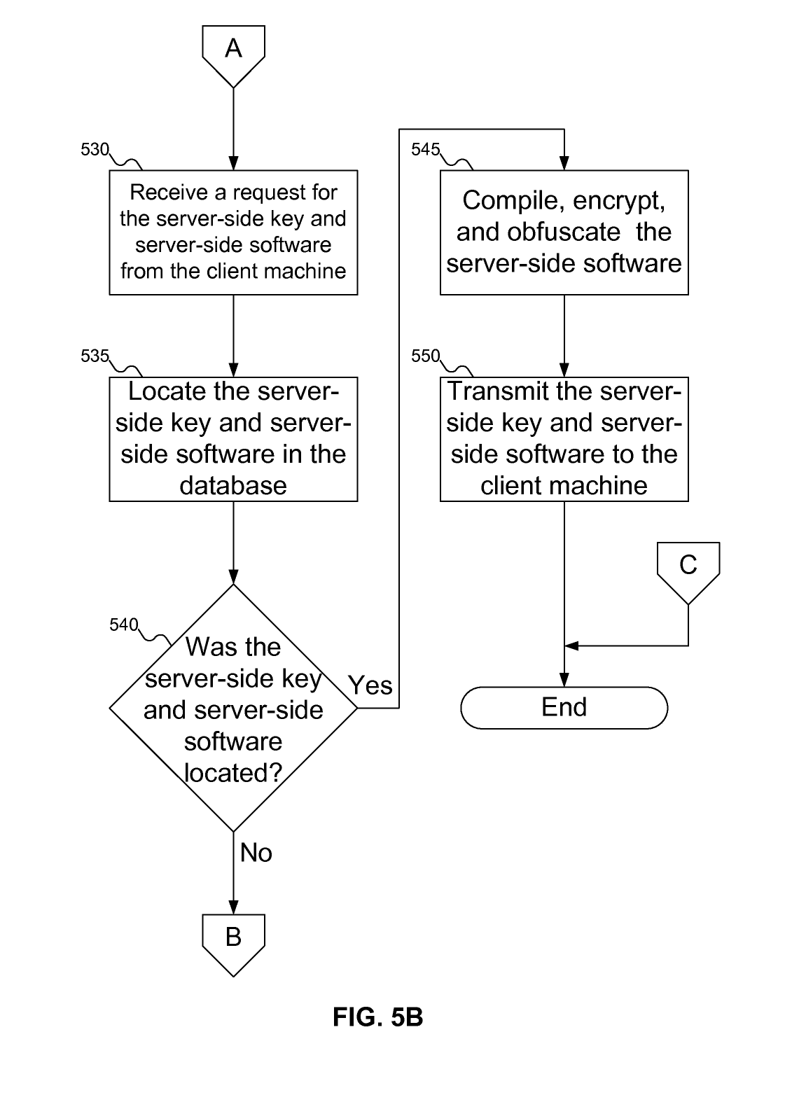

FIGS. 5A-5B show a flowchart of a procedure for the security server of FIG. 1 to communicate with a client machine regarding the assembly and execution of software, according to an embodiment of the invention. In FIG. 5A, at block 505, the security server receives an identity of a client machine. At block 510, the security server attempts to validate the client machine. At block 515, the security server determines whether the client machine was validated. Validation of the client machine can occur in any desired manner. For example, in some embodiments of the invention, as discussed above, the client-side software can include a client-side key. This client-side key can be transmitted to the security server. The security server can then validate the client-side key against its server-side key (for example, using an algorithm complimentary to that used by the client-side software to validate the server-side key), and compare the Internet Protocol (IP) address of the client machine against a database of recognized IP addresses. In such embodiments, validating the client machine would require the client-side key to be validated, and for the IP address of the client machine to be recognized and matched with the client-side key. A person skilled in the art will recognize other ways in which the client machine can be validated.

If the client machine was not validated, then at block 520 the security-side key can be changed (since it appears an attacker has an unauthorized copy of the client-side software), and at block 525 the security server transmits decoy information to the client machine. Otherwise, at block 530 (FIG. 5B), the security server receives a request from the client machine for the security-side software and the server-side key. At block 535, the security server locates the server-side software and server-side key, if they are available at the security server. At block 540, the security server determines if the server-side software and server-side key are available at the security server. If the server-side software and the server-side key are not available at the security server, then control passes to either of blocks 520 or 525, depending on the situation. (For example, if the security server should have the server-side software and the server-side key but does not, there may be a problem that needs correction, in which case control can pass to block 520. But if the security server is not supposed to have the server-side software and the server-side key, then the security server is a decoy, and control can pass to block 525 without changing the server-side key.) If the server-side software and the server-side key are available at the security server, then at block 545, the security server compiles, encrypts, and obfuscates the server-side software, and at block 550 the security server transmits the server-side software to the client machine.

In the flowcharts of FIGS. 4A-5B, the blocks are shown in one arrangement. A person skilled in the art will recognize that the blocks can be arranged in other configurations without any loss of applicability, and that various blocks can be omitted. For example, if the security server stores server-side software that is already compiled, encrypted, and obfuscated, then block 545 can be omitted with no loss of operability.

While the above discussion suggests that the software is divided into two parts—the client-side software and the server-side software—a person skilled in the art will recognize that the software can be divided into any number of parts. For example, the software can be divided into three parts: one part on the client machine (the client-side server) and two parts on security servers (two different server-side software elements). Combining all the parts of the software results in the usable version of the software.

When the software is split into more than two pieces, the server-side keys held by each security server including a portion of the software can be the same or different. That is, in some embodiments of the invention each security server that stores a portion of the software includes the same server-side key. But in other embodiments of the invention, each security server that stores a portion of the software can include a different server-side key. Provided that the client-side software can validate each server-side key, using more than one server-side key introduces no complications.

The above discussion focuses on software as the content being protected by embodiments of the invention. But a person skilled in the art will recognize that any content can be protected in the described manner, without being limited to software. For purposes of this application, the term “software” is defined to include any content, and not just code that can be executed by a computer processor. Where the content is not code that can be executed by a computer processor, the content can be protected by being just encrypted and obfuscated, without being compiled (which is a term that generally applies only to computer-executable code), and the phrase “compiled, encrypted, and obfuscated” can be understood as just “encrypted and obfuscated”.

In embodiments of the invention where the content being protected is not software, the client machine can include software that can implement the algorithms described above, to assemble the complete content for presentation to the user. Thus, while the content might not be software that can be executed by a computer processor, the user can still review the content in any desired and appropriate manner.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a security server;
a memory in the security server;
a database in the memory;
a server-side software stored in the database;
a server-side key stored in the database;
a receiver to receive from a client machine a request for the server-side key and the server-side software; and
a transmitter to transmit to the client machine the server-side key and the server-side software,
wherein the server-side software is compiled, encrypted, and obfuscated before it can be transmitted to the client machine.

2. A system according to claim 1, wherein:
the server-side software includes source code; and
the system further comprises a code generator to compile, encrypt, and obfuscate the source code before the server-side software can be transmitted to the client machine.

3. A system according to claim 1, wherein the server-side key is within the server-side software.

4. A system according to claim 1, wherein the transmitter is operative to transmit decoy information if the server-side key and the server-side software cannot be located in the database.

5. A system according to claim 1, wherein:
the receiver is operative to receive an identity of the client machine; and
the system further comprises a validator to validate the identity of the client machine.

6. A system according to claim 5, wherein the transmitter is operative to transmit decoy information if the identity of the client machine is not validated.

7. A system according to claim 1, wherein the server-side key stored in the database can be changed if an unauthorized request for the server-side software is received.

8. A method, comprising:
receiving at a server a request for a server-side key and a server-side software from a client machine;
locating the server-side key and the server-side software in a database; and
transmitting the server-side key and the server-side software to the client machine.

9. A method according to claim 8, wherein the server-side software in the database is compiled, encrypted, and obfuscated.

10. A method according to claim 8, wherein:
the server-side software in the database is source code; and
the method further comprises compiling, encrypting, and obfuscating the source code before transmitting the server-side key and the server-side software to the client machine.

11. A method according to claim 8, wherein the server-side key is within the server-side software.

12. A method according to claim 8, wherein transmitting the server-side key and the server-side software to the client machine includes transmitting decoy information if the server-side key and the server-side software cannot be located in the database.

13. A method according to claim 8, further comprising:
receiving an identity of the client machine; and
validating the identity of the client machine.

14. A method according to claim 13, wherein transmitting the server-side key and the server-side software to the client machine includes transmitting decoy information if the identity of the client machine is not validated.

15. A method according to claim 8, further comprising changing the server-side key if an unauthorized request for the server-side software is received.

16. An article, comprising a non-transitory storage medium, said non-transitory storage medium having stored thereon instructions that, when executed by a machine, result in performing the method of claim 8.

17. A method, comprising:
validating a client machine executing a client-side software;
requesting a server-side key and a server-side software from a security server by the client-side software;
receiving at the client machine the server-side key and a server-side software from the security server;
validating the server-side key;
combining the client-side software and the server-side software into a combined software; and
executing the combined software.

18. A method according to claim 17, wherein requesting a server-side key and a server-side software from a security server by the client-side software includes requesting the server-side key from a plurality of security servers, the plurality of security servers including at least one security server that includes the server-side key and the server-side software and at least one security server that does not include the server-side key and the server-side software.

19. A method according to claim 18, wherein receiving a server-side key and a server-side software from the security server includes:
receiving the server-side key and the server-side software from the security server including receiving the server-side key and the server-side software from the at least one security server that includes the server-side key and the server-side software; and
receiving decoy information from the security server that does not include the server-side key and the server-side software.

20. A method according to claim 17, wherein the combined software cannot be deciphered from a memory of the client machine.
